(19) United States
(12) Patent Application Publication
(10) Pub. No.: US 2017/0357800 A1
(43) Pub. Date: Dec. 14, 2017

(54) Method for dynamically generating a long password after successful biometric verification and updating all services associated to the user's account with the new encrypted long password

(71) Applicants: Thien Pham, Lacey, WA (US); Wayne Taylor, Chandler, AZ (US); Gerard Munera, Greenwhich, CT (US)

(72) Inventors: Thien Pham, Lacey, WA (US); Wayne Taylor, Chandler, AZ (US); Gerard Munera, Greenwhich, CT (US)

(21) Appl. No.: 15/180,037

(22) Filed: Jun. 12, 2016

(51) Int. Cl. G06F 21/46; G06F 21/32; H04L 9/06; H04L 9/00

(52) U.S. Cl. CPC G06F 21/46; H04L 9/006; G06F 21/32; H04L 9/0631

(57) ABSTRACT

Method for dynamically generating a long password after successful biometric verification and updating all services associated to the user's account with the new encrypted long password.

Method for dynamically generating a long password after successful biometric verification and updating all services associated to the user's account with the new encrypted long password.

### CROSS-REFERENCE TO RELATED APPLICATIONS

Not Applicable.

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The present invention relates generally to a computer program that dynamically changes a user's account password with a long string that is encrypted with an encryption algorithm after successful biometric verification. More specifically, the present invention relates to validating the user's biometric signature, generating a long string that is greater than or equal to 20 characters, encrypting it with an encryption algorithm, connecting to the user's service accounts, and updating the user's service account passwords with the new encrypted password.

### BACKGROUND OF THE INVENTION

User account passwords created by people are short and represents something about them. Having this type of password can be easily hacked and it is a common occurrence for many websites and applications.

What is needed is a method for validating a user's biometric signature, dynamically generating a long string that is 20 or more characters long, encrypting it with an encryption algorithm, connecting to the user's service accounts, and updating the user's service account passwords with the new encrypted password that is greater than or equal to 20 characters.

### BRIEF SUMMARY OF THE INVENTION

In a typical application, a user accesses a website, application, or device that requires biometric verification and gives access to various services upon successful verification. First, the user signs in using any biometric verification process, such as finger print, facial scan, iris scan, signature captured by the movement of a computer mouse, stylus or finger, or other biometric. Once the user's biometric has been verified, the application generates a long string that is greater than or equal to 20 characters. The application then encrypts the long password using an encryption algorithm. The application then connects to all services associated to the user's account and updates the passwords with the new encrypted long string that is greater than or equal to 20 characters.

### BRIEF DESCRIPTION OF THE SEVERAL VIEWS OF THE DRAWING

FIG. 1 illustrates the process of the present invention.

### DETAILED DESCRIPTIONS OF THE INVENTION

The invention is now described in detail with reference to an embodiment thereof as illustrated in the accompanying drawing. In the following description, numerous specific details are set forth in order to provide thorough understanding of the present disclosure. It is apparent, however, to one skilled in the art, that the present discloser may be practiced without some or all of these specific details. In other instances, well known process steps and/or structures have not been described in detail in order not to unnecessarily obscure the present disclosure. In addition, while the disclosure is described in conjunction with the particular embodiment, it should be understood that this description is not intended to limit the disclosure to the described embodiment. To the contrary, the description is intended to cover alternatives, modifications, and equivalents as may be included within the spirit and scope of the disclosure as defined by the appended claims.

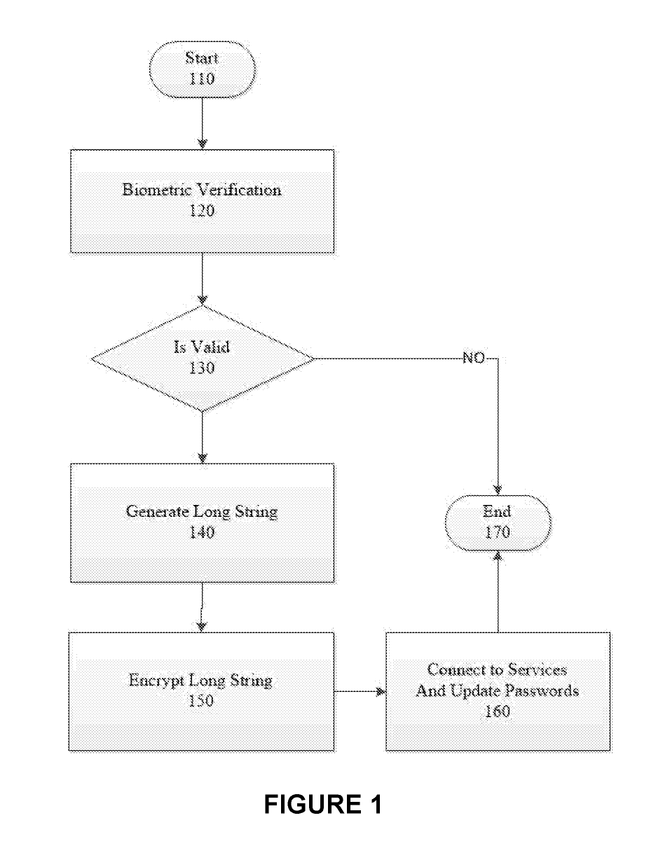

FIG. 1 illustrates the process of the present invention, which is a computer program, for validating the user's biometric signature, generating a long string that is greater than or equal to 20 characters, encrypting it with an encryption algorithm, and connecting to all services associated to the user's account to update the passwords with the new encrypted long string that is greater than or equal to 20 characters.

First the program starts at Step 110. The program then continues to Step 120 where the program verifies the user's biometric, either finger print, facial scan, iris scan, signature captured by the movement of a computer mouse, stylus or finger, or other biometric and continues to Step 130. At Step 130, if the biometric verification is not valid, the program continues to Step 170 and the program ends. At Step 130, if the biometric verification is valid, the program continues to Step 140. At Step 140, the program generates a random string that is greater than or equal to 20 characters and continues to Step 150. At Step 150, the program encrypts the password using any encryption algorithm, such as AES, Public Key Infrastructure, or other encryption algorithm and continues to Step 160. At Step 160, the program connects to all services associated to the user's account and updates the old password with the encrypted newly generated long string that is greater than or equal to 20 characters and continues to Step 170, where the program ends.

What is claimed is:

1. A method for validating a user's biometric signature, dynamically generating a long string that is greater than or equal to 20 characters, encrypting the long string with an encryption algorithm, connecting to all services associated to the user's account to update the passwords with the new encrypted long string that is greater than or equal to 20 characters comprising the steps of:
(a) verifying the user's biometric signature
(b) generating a long string that is greater than or equal to 20 characters
(c) encrypting the long string with an encryption algorithm
(d) connecting to all services associated with the user's account to update the passwords with the new encrypted long string that is greater than or equal to 20 characters

2. The method of claim 1, wherein the biometric verification is finger print, facial scan, iris scan, signature captured by a computer mouse, stylus or finger, or other biometric.

3. The method of claim 1, wherein the string is greater than or equal to 20 characters.

4. The method of claim 1, wherein the encryption algorithm can be any encryption algorithm, such as AES, Public Key Infrastructure, or other encryption algorithm.
